(19) United States
(12) Patent Application Publication
(10) Pub. No.: US 2025/0376087 A1
(43) Pub. Date: Dec. 11, 2025

(54) VEHICLE SEAT

(71) Applicant: TACHI-S CO., LTD., Tokyo (JP)

(72) Inventors: Yasuhiro SUZUKI, Tokyo (JP); Mitsuhisa NAKAMURA, Tokyo (JP); Takeshi NISHINA, Tokyo (JP)

(73) Assignee: TACHI-S CO., LTD., Tokyo (JP)

(21) Appl. No.: 19/223,037

(22) Filed: May 30, 2025

(30) Foreign Application Priority Data
Jun. 5, 2024 (JP) 2024-091215

(51) Int. Cl. B60N 2/16

(52) U.S. Cl. CPC B60N 2/165; B60N 2/1605

(57) ABSTRACT

A vehicle seat includes a drive link member provided with a second gear meshing with a first gear supported by a seat cushion and pivoted according to pivoting of the first gear, a hole provided in the drive link member and having a shape along an arc of a circle centered on a pivoting center of the drive link member, a restriction member inserted into the hole, supported at one end by the seat cushion, and restricting a pivoting range of the drive link member, and a support member supporting an other end of the restriction member and support a shaft of the first gear. In a direction connecting the pivoting center and the restriction member, a distance between an edge of the hole on a second gear side and the restriction member is smaller than a distance between an opposite edge of the hole and the restriction member.

### CROSS-REFERENCE TO RELATED APPLICATIONS

This application is based on and claims priority under 35 USC 119 from Japanese Patent Application No. 2024-091215 filed on Jun. 5, 2024, the entire content of which is incorporated herein by reference.

### TECHNICAL FIELD

The present disclosure relates to a vehicle seat.

### BACKGROUND ART

JP2008-087554A describes a vehicle seat including a sector gear operatively coupled to one of link members coupled by a torque rod and having an arc-shaped long hole formed therein, a pinion gear rotatably supported by a lower arm and meshing with the sector gear, a pressing bracket pivotally supported by the pinion gear, and a stopper pin inserted through the long hole of the sector gear and having one end coupled to the lower arm and the other end coupled to the pressing bracket.

JP5846391B describes a vehicle seat including a pair of connection members that connect a pair of sliders of a slide mechanism and a seat cushion frame, and a coupling member that couples the pair of connection members to each other in a vehicle width direction so as to prevent the displacement of the pair of connection members in a direction in which the pair of connection members approach each other in a rear collision.

JP2013-112150A describes a vehicle seat including a height adjustment mechanism that supports a seating portion so as to be movable up and down, and a height brake that is fixed to a side frame and is engaged with the height adjustment mechanism to lock a height position of the seating portion.

JP4452711B describes a vehicle seat including a multi-link mechanism that functions as a four-link mechanism and sets a seat height.

JP5233547B describes a structure in which a side frame is assembled to an upper rail in a state where a gap is formed in a part between the upper rail and the side frame, the side frame is assembled with a restriction bracket including a hook portion that closes a part or the entirety of the gap, and the hook portion is set to interfere with a lower rail or the upper rail in a slide mechanism when a rear collision occurs in a vehicle.

An object of the present disclosure is to provide a vehicle seat capable of improving a strength.

### SUMMARY OF INVENTION

According to an aspect of the present disclosure, there is provided a vehicle seat including:
a seat cushion;
a height adjustment mechanism for the seat cushion;
a drive link member provided with a second gear meshing with a first gear supported by the seat cushion, and configured to be pivoted according to pivoting of the first gear;
a long hole provided in the drive link member and having a shape along an arc of a circle centered on a pivoting center of the drive link member;
a restriction member inserted into the long hole, supported at one end by the seat cushion, and configured to restrict a pivoting range of the drive link member; and
a support member configured to support an other end of the restriction member and support a shaft of the first gear, in which
in a direction connecting the pivoting center of the drive link member and the restriction member, a first distance between an end edge of the long hole on a second gear side and the restriction member is smaller than a second distance between an end edge of the long hole on a side opposite to the second gear side and the restriction member.

### BRIEF DESCRIPTION OF DRAWINGS

Exemplary embodiment(s) of the present invention will be described in detail based on the following figures, wherein:

FIG. 1 is an external perspective view illustrating a schematic configuration of a vehicle seat 100 according to an embodiment of the technique of the present disclosure;

FIG. 2 is a partially enlarged perspective view schematically illustrating an internal configuration of the vehicle seat 100 illustrated in FIG. 1;

FIG. 3 is a partially enlarged perspective view schematically illustrating the internal configuration of the vehicle seat 100 illustrated in FIG. 1, as viewed from a direction different from that in FIG. 2;

FIG. 4 is a schematic view of the vicinity of a rear end portion of a left side frame 11L as viewed from a right side;

FIG. 5 is a schematic cross-sectional view taken along line A-A in FIG. 4;

FIG. 6 is a schematic cross-sectional view taken along line B-B in FIG. 4;

FIG. 7 is a perspective view schematically illustrating configurations of a fixing bracket 64 and a reinforcing plate 65; and

FIG. 8 is an enlarged view of a main portion of the vehicle seat 100 in the vicinity of a rear end portion of a left rear link member 61L as viewed from the right side.

### DESCRIPTION OF EMBODIMENTS

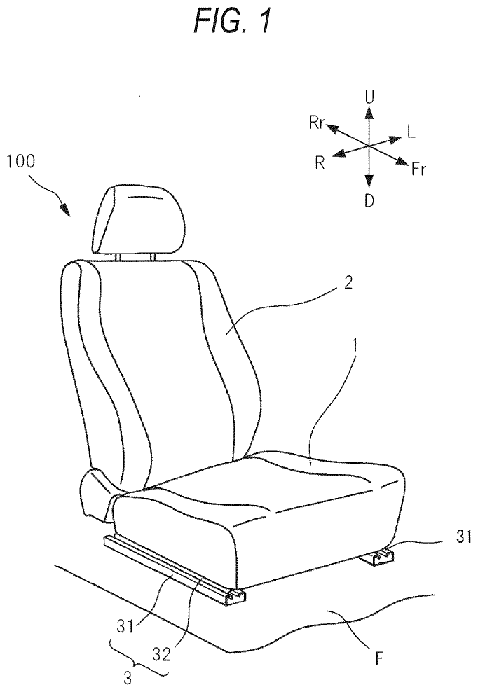

FIG. 1 is an external perspective view illustrating a schematic configuration of a vehicle seat 100 according to an embodiment of the technique of the present disclosure. The vehicle in the present specification includes an automatic vehicle, an aircraft, a train, a moving drone, a ship, and the like. In the following description, a front side of an occupant who sits in a normal posture on the vehicle seat 100 is referred to as a frontward direction Fr, a direction opposite to the frontward direction Fr is referred to as a rearward direction Rr, and the frontward and rearward directions are collectively referred to as a front-rear direction. A right side of the occupant when the occupant is viewed from a rear side is referred to as a rightward direction R, a left side of the occupant is referred to as a leftward direction L, and the leftward and rightward directions are collectively referred to as a left-right direction. A direction perpendicular to the front-rear direction and the left-right direction and extending from a head rest toward a seating surface is referred to as a downward direction D, a direction opposite to the downward direction D is referred to as an upward direction U, and the upward and downward directions are collectively referred to as an up-down direction. The front-rear direction, the left-right direction, and the up-down direction intersect with each other.

The vehicle seat 100 includes a seat cushion 1 that supports buttocks and thighs of the occupant, and a seat back 2 that supports a waist and a back of the occupant. In the example of FIG. 1, the vehicle seat 100 is a driver's seat or a passenger's seat of an automatic vehicle.

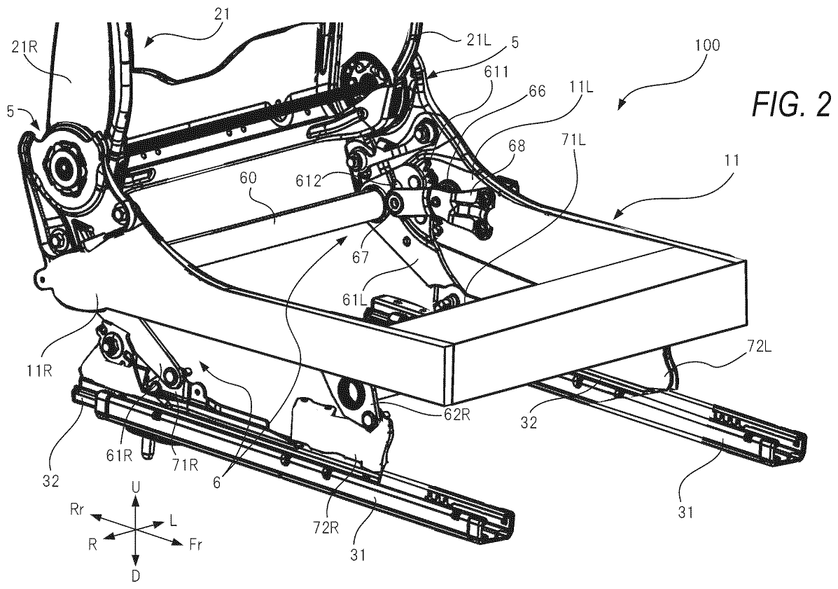

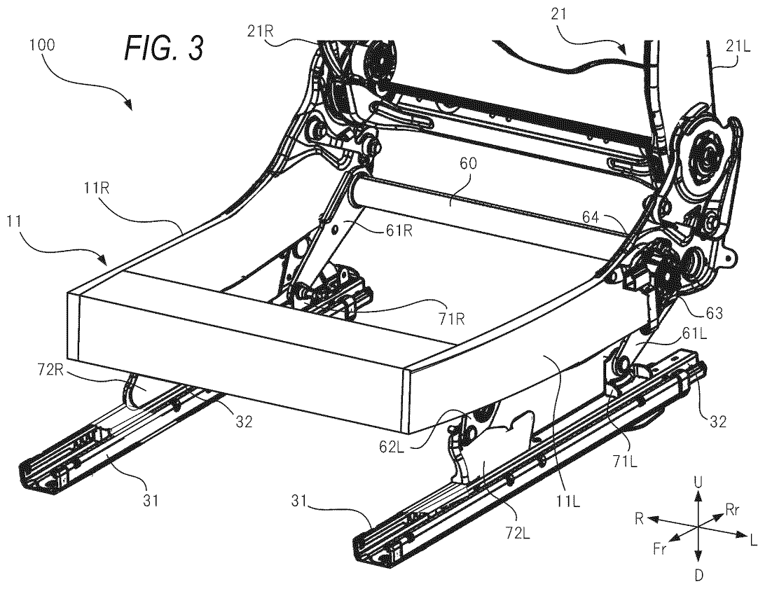

The seat cushion 1 includes a cushion frame 11 (see FIGS. 2 and 3) that forms a framework. The cushion frame 11 is covered with a pad (not illustrated) made of a relatively soft resin foam material such as urethane foam, and is further covered with a trim cover (not illustrated) including a skin material such as leather, woven fabric, or nonwoven fabric.

The seat back 2 includes a back frame 21 (see FIGS. 2 and 3) that forms a framework (not illustrated). The back frame 21 is covered with a pad (not illustrated) made of a relatively soft resin foam material such as urethane foam, and is further covered with a trim cover (not illustrated) including a skin material such as leather, woven fabric, or nonwoven fabric.

The vehicle seat 100 includes a pair of rail mechanisms 3 fixed to a vehicle body floor F and located directly below the seat cushion 1, and a foot bracket (not illustrated) disposed between the rail mechanisms 3 and the vehicle body floor F and supporting the seat cushion 1 from below via the rail mechanisms 3.

The rail mechanism 3 is located directly below the seat cushion 1 to support the seat cushion 1, and can cause the seat cushion 1 to move along the front-rear direction. The rail mechanism 3 includes two long rails extending in the front-rear direction, specifically, a lower rail 31 as a fixed rail and an upper rail 32 as a movable rail. The upper rail 32 can slide along a longitudinal direction (that is, the front-rear direction) of the lower rail 31 together with the seat cushion 1 supported on an upper surface thereof.

FIG. 2 is a partially enlarged perspective view schematically illustrating an internal configuration of the vehicle seat 100 illustrated in FIG. 1. FIG. 2 illustrates a state where a pad and a trim cover of the seat cushion 1 and a pad and a trim cover of the seat back 2 are removed. FIG. 3 is a partially enlarged perspective view schematically illustrating the internal configuration of the vehicle seat 100 illustrated in FIG. 1, as viewed from a direction different from that in FIG. 2.

The cushion frame 11 of the seat cushion 1 includes a left side frame 11L and a right side frame 11R arranged side by side in the left-right direction and extending in the front-rear direction. In the example of FIGS. 2 and 3, the left side frame 11L and the right side frame 11R are each formed in a plate shape having a thickness in the left-right direction.

The back frame 21 of the seat back 2 includes a left side frame 21L and a right side frame 21R arranged side by side in the left-right direction and extending in the up-down direction. In the example of FIGS. 2 and 3, the left side frame 21L and the right side frame 21R are each formed in a plate shape having a thickness in the left-right direction.

The vehicle seat 100 includes a reclining device 5 that adjusts the inclination of the seat back 2 with respect to the seat cushion 1, and a seat lifter device 6 that adjusts a height position of the seat cushion 1 in the up-down direction. The seat lifter device 6 includes a parallel link mechanism, and includes a left rear link member 61L provided at the rear left, a right rear link member 61R provided at the rear right, a left front link member 62L provided at the front left, a right front link member 62R provided at the front right, and a cylindrical torque rod 60 made of a pipe material or the like, which rotatably passes through holes that penetrate to the left and right and are formed in a rear end portion of the left side frame 11L and a rear end portion of the right side frame 11R, respectively.

The left rear link member 61L has a lower end side pivotably coupled to a riser 71L via a hinge pin or the like, and an upper end side coupled to a left end portion of the torque rod 60. As illustrated in FIG. 3, a motor 63 is fixed to a left side surface of the left side frame 11L via a fixing bracket 64. The motor 63 is an example of an electric drive device that operates when an operation button (not illustrated) or the like is operated. A power of the motor 63 can be transmitted to the left rear link member 61L.

The right rear link member 61R has a lower end side pivotably coupled to a riser 71R via a hinge pin or the like, and an upper end side coupled to a right end portion of the torque rod 60.

The left front link member 62L has a lower end side pivotably coupled to a riser 72L via a hinge pin or the like, and an upper end side pivotably coupled to a front end portion of the left side frame 11L.

The right front link member 62R has a lower end side pivotably coupled to a riser 72R via a hinge pin or the like, and an upper end side pivotably coupled to a front end portion of the right side frame 11R.

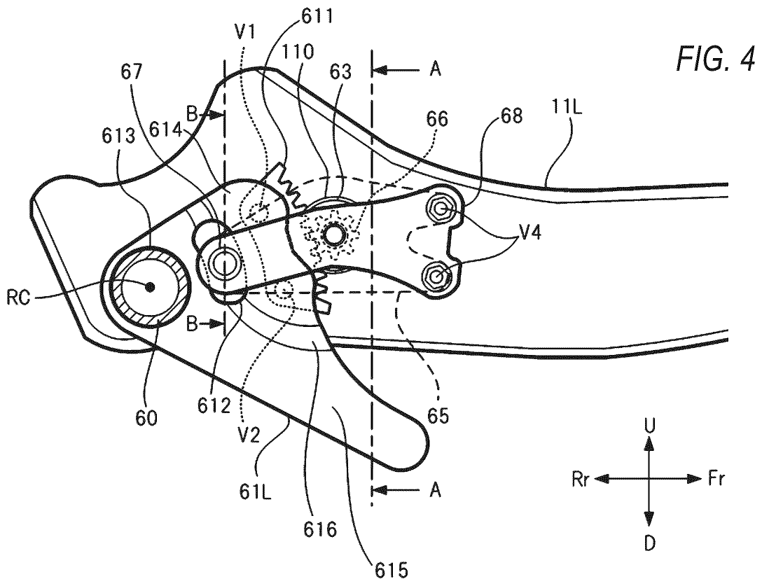

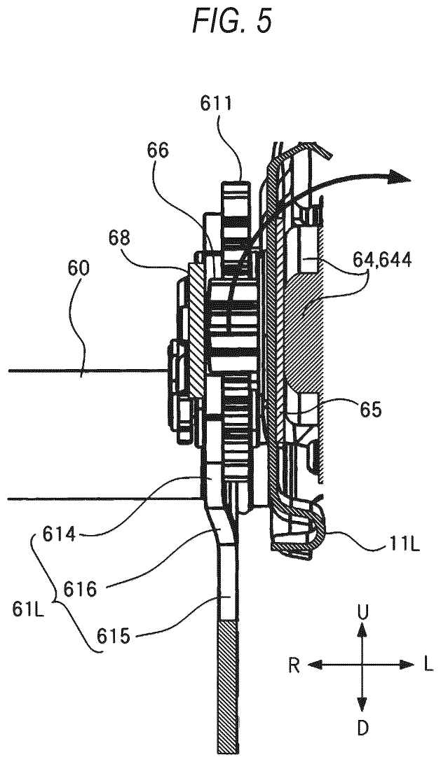

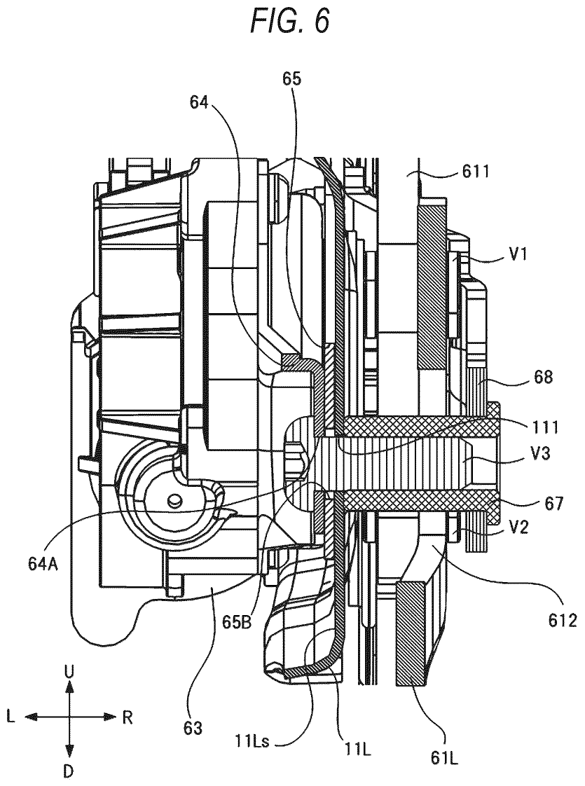

FIG. 4 is a schematic view of the vicinity of the rear end portion of the left side frame 11L as viewed from a right side. FIG. 5 is a schematic cross-sectional view taken along line A-A in FIG. 4. FIG. 6 is a schematic cross-sectional view taken along line B-B in FIG. 4.

As illustrated in FIG. 4, the left side frame 11L is provided with a through hole 110 penetrating in the left-right direction. A pinion gear 66 is fixed to an output shaft of the motor 63 fixed to the left side frame 11L by the fixing bracket 64. As illustrated in FIG. 5, the pinion gear 66 is inserted into the through hole 110 from a left side of the left side frame 11L and is disposed on a right side of the left side frame 11L.

The left rear link member 61L is formed in a plate shape having a thickness in the left-right direction, and as illustrated in FIG. 4, the torque rod 60 is coupled to a through hole 613 penetrating in the left-right direction. The left rear link member 61L is provided with a sector gear 611 that meshes with the pinion gear 66 between the pinion gear 66 and the through hole 613. The sector gear 611 is fastened to the left rear link member 61L by a fastening member V1 and a fastening member V2 such as bolts and nuts. As illustrated in FIGS. 5 and 6, the sector gear 611 is provided between the left side frame 11L and the left rear link member 61L.

When the motor 63 operates and the pinion gear 66 pivots, the sector gear 611 meshing with the pinion gear 66, the left rear link member 61L integrated with the sector gear 611, and the torque rod 60 coupled to the left rear link member 61L pivot about an axial center RC (see FIG. 4) of the torque rod 60 as a pivoting center in accordance with the pivoting of the pinion gear 66. When the torque rod 60 pivots, the right rear link member 61R coupled to the torque rod 60 also pivots, the left front link member 62L and the right front link member 62R also pivot, and the cushion frame 11 moves in the up-down direction.

In this way, the left rear link member 61L, the right rear link member 61R, the left front link member 62L, the right front link member 62R, the torque rod 60, the left side frame 11L, the right side frame 11R, the riser 71L, the riser 71R, the riser 72L, and the riser 72R constitute the parallel link mechanism that causes the seat cushion 1 to move in the up-down direction while maintaining a posture with respect to the vehicle body floor F.

As illustrated in FIG. 5, the left rear link member 61L includes a first region 614 facing the left side frame 11L with the sector gear 611 interposed therebetween, a second region 615 located closer to the left side frame 11L than the first region 614, and a third region 616 connecting the first region 614 and the second region 615. The sector gear 611 is fastened to the first region 614 by the fastening member V1 and the fastening member V2 (see FIG. 4).

A lower end portion of the second region 615 illustrated in FIG. 5 is pivotably coupled to the riser 71L. A position of the lower end portion is restricted by a position of the upper rail 32 in the left-right direction. On the other hand, the sector gear 611 is provided between the first region 614 and the left side frame 11L, and thus in order to make a position of the sector gear 611 in the left-right direction the same as that of the second region 615, it is necessary to move the sector gear 611, the motor 63, or the like rightward from the state of FIG. 5. As illustrated in FIG. 5, the positions of the first region 614 and the second region 615 in the left-right direction are shifted from each other, and thus the sector gear 611, the motor 63, or the like can be disposed further inward in the seat, which contributes to reducing a lateral width of the seat.

In this way, when the positions of the first region 614 and the second region 615 in the left-right direction are changed, a strength of the left rear link member 61L in a thickness direction is lower in the third region 616 than in the other regions.

As illustrated in FIG. 4, in the left rear link member 61L, a long hole 612 having a shape along an arc of a circle centered on the axial center RC is provided between the sector gear 611 and the through hole 613 so as to penetrate in the left-right direction.

As illustrated in FIG. 6, a cylindrical restriction pin 67 extending in the left-right direction is inserted into the long hole 612. The left side frame 11L is provided with a through hole 111 penetrating in the left-right direction at a position facing one end (left end) of the restriction pin 67. The left end of the restriction pin 67 is fastened to and supported by the left side frame 11L together with the fixing bracket 64 and the reinforcing plate 65 between the fixing bracket 64 and the left side frame 11L by a fastening member V3 such as a bolt or a screw inserted into the through hole 111 from the left side of the left side frame 11L. A pivoting range of the left rear link member 61L is restricted by the restriction pin 67. That is, the left rear link member 61L is pivotable between a position at which the restriction pin 67 abuts against one end of the long hole 612 in the longitudinal direction and a position at which the restriction pin 67 abuts against the other end of the long hole 612 in the longitudinal direction.

The vehicle seat 100 is further provided with a pressing bracket 68 that supports the other end (right end) of the restriction pin 67 and supports a shaft of the pinion gear 66. The pressing bracket 68 is formed in a plate shape having a thickness in the left-right direction, and is provided rightward of the left rear link member 61L as illustrated in FIGS. 5 and 6.

As illustrated in FIG. 4, the pressing bracket 68 extends in the front-rear direction from a position of the restriction pin 67 across the pinion gear 66. The pressing bracket 68 is fixed to the restriction pin 67 at a rear end portion. The pressing bracket 68 is fastened to the left side frame 11L together with the fixing bracket 64 and the reinforcing plate 65 at two positions at a front end portion by fastening members V4 such as bolts or screws. The left side frame 11L is provided with a through hole penetrating in the left-right direction at a position facing the two fastening members V4. The pressing bracket 68 pivotably supports the shaft of the pinion gear 66 between front and rear fastening portions.

As illustrated in FIGS. 5 and 6, a plate-shaped reinforcing plate 65 formed in a plate shape having a thickness in the left-right direction is provided between the fixing bracket 64 and the left side frame 11L. The reinforcing plate 65 is fastened to a left surface 11Ls (see FIG. 6) of the left side frame 11L together with the fixing bracket 64.

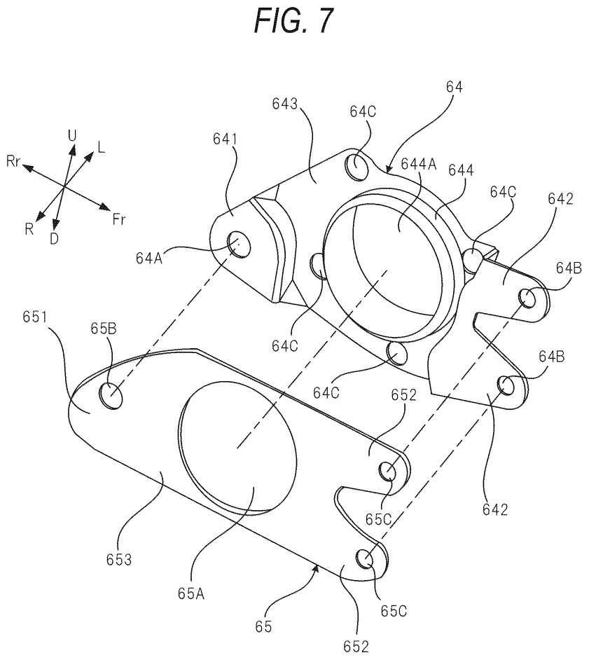

FIG. 7 is a perspective view schematically illustrating the configurations of the fixing bracket 64 and the reinforcing plate 65. The fixing bracket 64 has a shape extending in the front-rear direction along the pressing bracket 68. The fixing bracket 64 includes a first surface portion 641 fastened to the surface 11Ls of the left side frame 11L by the fastening member V3 (see FIG. 6), a second surface portion 642 fastened to the surface 11Ls of the left side frame 11L by the fastening members V4 (see FIG. 4), a third surface portion 643 fastened to the motor 63, and a tubular portion 644 having, for example, a cylindrical shape protruding from the third surface portion 643 toward the left side frame 11L. The third surface portion 643 is provided between the first surface portion 641 and the second surface portion 642, and is provided at a position farther from the left side frame 11L than the first surface portion 641 and the second surface portion 642.

Each of the first surface portion 641 and the second surface portion 642 has, for example, a flat plate shape perpendicular to the left-right direction. The first surface portion 641 is provided with a fastening hole 64A penetrating in the thickness direction. The second surface portion 642 has two fastening holes 64B arranged vertically and penetrating therethrough in the thickness direction. The third surface portion 643 is located on the left side of the first surface portion 641 and the second surface portion 642, and has a flat plate shape perpendicular to the left-right direction. The third surface portion 643 is provided with four fastening holes 64C penetrating in the thickness direction around the tubular portion 644.

The motor 63 is fastened to a left surface of the third surface portion 643 by fastening members such as bolts or screws inserted into the four fastening holes 64C. The output shaft of the motor 63 is disposed on an inner peripheral portion 644A of the tubular portion 644, and the pinion gear 66 is provided on the inner peripheral portion 644A.

The reinforcing plate 65 has a shape extending in the front-rear direction along the pressing bracket 68. The reinforcing plate 65 is provided with an opening portion 65A penetrating in the thickness direction at a position facing the inner peripheral portion 644A of the tubular portion 644 of the fixing bracket 64, a fastening hole 65B penetrating in the thickness direction at a position facing the fastening hole 64A of the fixing bracket 64, and fastening holes 65C penetrating in the thickness direction at positions facing the fastening holes 64B of the fixing bracket 64.

As illustrated in FIG. 6, the fastening hole 64A of the fixing bracket 64, the fastening hole 65B of the reinforcing plate 65, the through hole 111 of the left side frame 11L, and the restriction pin 67 are disposed to overlap each other in the left-right direction, and are fastened by the fastening member V3. The pinion gear 66 disposed in the inner peripheral portion 644A is inserted into the opening portion 65A of the reinforcing plate 65 and the through hole 110 (see FIG. 4) of the left side frame 11L, and is disposed inside the left side frame 11L.

The fastening holes 64B of the fixing bracket 64, the fastening holes 65C of the reinforcing plate 65, the through hole provided in the left side frame 11L, and a right end portion of the pressing bracket 68 are disposed to overlap each other in the left-right direction, and are fastened by the fastening members V4.

The reinforcing plate 65 has a first region 651 in surface contact with the first surface portion 641 of the fixing bracket 64, a second region 652 in surface contact with the second surface portion 642 of the fixing bracket 64, and a third region 653 facing the third surface portion 643 of the fixing bracket 64.

In a state where the fixing bracket 64 and the reinforcing plate 65 are fastened to the left side frame 11L, as illustrated in FIG. 5, a part of the third region 653 of the reinforcing plate 65 abuts against a distal end surface of the tubular portion 644. The fixing bracket 64 has the third surface portion 643 located far from the left side frame 11L in order to fasten the motor 63 to a left surface. Therefore, a fastening strength of the fixing bracket 64 to the left side frame 11L decreases between the left side frame 11L and the third surface portion 643.

The reinforcing plate 65 is provided with the flat plate-shaped third region 653 facing the third surface portion 643, and the third region 653 is in surface contact with the left side frame 11L. By providing the reinforcing plate 65, a fastening force between the fixing bracket 64 and the left side frame 11L can be increased.

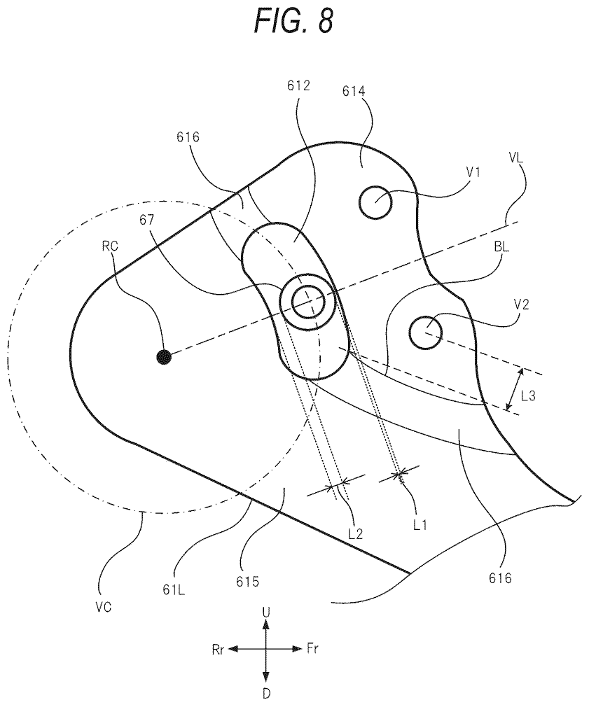

FIG. 8 is an enlarged view of a main portion of the vehicle seat 100 in the vicinity a rear end portion of the left rear link member 61L as viewed from the right side. FIG. 8 illustrates a straight line VL connecting the axial center RC and the restriction pin 67 and a circle VC centered on the axial center RC. When the left rear link member 61L pivots, the restriction pin 67 moves relative to the long hole 612 along an arc of the circle VC.

FIG. 8 illustrates a distance L1 between an end edge of the long hole 612 on a sector gear 611 side and the restriction pin 67 in a direction in which the straight line VL extends, and a distance L2 between an end edge of the long hole 612 on a side opposite to the sector gear 611 side and the restriction pin 67 in the direction in which the straight line VL extends. The distance L1 is smaller than the distance L2.

When an impact is applied from behind to a vehicle on which the vehicle seat 100 is mounted, a downward force is applied to the left rear link member 61L. The movement of the left rear link member 61L is locked by the engagement between the sector gear 611 and the pinion gear 66. Therefore, a reaction force in the upward direction U of the force applied to the left rear link member 61L is transmitted to the pinion gear 66, and this reaction force is transmitted from the pinion gear 66 to the reinforcing plate 65 and the fixing bracket 64 via the pressing bracket 68.

Therefore, when the impact occurs, a force acts on the restriction pin 67 to move in the upward direction U within the long hole 612. When the distance L1 is smaller than the distance L2, a movement distance of the restriction pin 67 when the restriction pin 67 moves in the upward direction U, for example, from the state illustrated in FIG. 8 can be shortened as compared with a case in which the distance L1 is equal to or larger than the distance L2. This is because when the distance L1 is small, a distance until the restriction pin 67 comes into contact with an edge portion of the long hole 612 is shortened. The distance L1 is not particularly limited, and is preferably set to about 1 mm to 3 mm. When the distance L2 is larger than the distance L1, the restriction pin 67 can be relatively moved smoothly in the long hole 612 even if manufacturing variations occur in the shape of the long hole 612.

FIG. 8 illustrates, as a distance L3, a shortest distance between a boundary BL between the first region 614 and the third region 616 and a fastening point (fastening member V2) closest to the boundary BL among fastening points (fastening member V1 and fastening member V2) of the first region 614 with the sector gear 611.

As described above, when a force in the upward direction U is applied to the pinion gear 66, a force acts on the pinion gear 66 and the motor 63 coupled to the pinion gear 66 to pivot counterclockwise, as indicated by a thick arrow in FIG. 5. When the pinion gear 66 pivots counterclockwise in the state illustrated in FIG. 5, a force acts on the sector gear 611 to be inclined in the leftward direction L in FIG. 5. The third region 616 is a portion having a low strength, and thus this force causes the boundary BL between the first region 614 and the third region 616 to move in the rightward direction R in FIG. 5, whereby the first region 614 is inclined leftward. The force to cause the first region 614 of the left rear link member 61L to be inclined leftward can be made smaller as the distance L3 illustrated in FIG. 8 is made smaller. As a section modulus of the boundary BL is increased, the inclination of the first region 614 can be prevented.

In order to increase the section modulus of the boundary BL, it is a normal design means to increase a plate thickness, but in order to reduce a weight of the left rear link member 61L, it is effective to set the distance L3 within a certain range.

As a result of the verification, it has been found that the inclination of the first region 614 of the left rear link member 61L can be prevented to such an extent that there is no practical problem while reducing the weight of the left rear link member 61L and securing a strength required for the left rear link member 61L by setting the distance L3 to 15 mm or more and 24 mm or less. By preventing the inclination of the first region 614, the meshing between the sector gear 611 and the pinion gear 66 can be prevented from becoming shallow, thereby improving a strength of gear teeth.

As described above, the following matters are disclosed in the present specification. In the following parentheses, corresponding components and the like in the above embodiment are described, but the present invention is not limited thereto.
(1) A vehicle seat (vehicle seat 100) including:
a seat cushion (seat cushion 1);
a height adjustment mechanism (seat lifter device 6) for the seat cushion;
a drive link member (left rear link member 61L) provided with a second gear (sector gear 611) meshing with a first gear (pinion gear 66) supported by the seat cushion and configured to be pivoted according to pivoting of the first gear;
a long hole (long hole 612) provided in the drive link member and having a shape along an arc of a circle (circle VC) centered on a pivoting center (axial center RC) of the drive link member;
a restriction member (restriction pin 67) inserted into the long hole, supported at one end by the seat cushion, and configured to restrict a pivoting range of the drive link member; and
a support member (pressing bracket 68) configured to support an other end of the restriction member and support a shaft of the first gear, in which
in a direction connecting the pivoting center of the drive link member and the restriction member, a first distance (distance L1) between an end edge of the long hole on a second gear side and the restriction member is smaller than a second distance (distance L2) between an end edge of the long hole on a side opposite to the second gear side and the restriction member.

According to (1), when a force for causing the drive link member to pivot is generated, a reaction force of the force is transmitted to the restriction member, and the restriction member moves in a direction intersecting a direction in which the long hole extends. The restriction member is provided at a position close to the second gear in the long hole, and thus even when the restriction member moves in the above direction, a movement distance thereof can be shortened. Therefore, the movement of the restriction member, the support member that supports the restriction member, and the first gear supported by the support member can be reduced by the contact between the restriction member and an edge portion of the long hole. Therefore, the meshing between the first gear and the second gear can be prevented from becoming shallow, thereby improving a strength of the seat.
(2) The vehicle seat according to (1) further including:
an electric drive device (motor 63) provided on a side opposite to the support member across a frame (left side frame 11L) of the seat cushion, and configured to drive the first gear;
a fixing bracket (fixing bracket 64) provided between the electric drive device and the frame, and configured to fix the electric drive device to the frame; and
a plate member (reinforcing plate 65) provided between the fixing bracket and the frame.

According to (2), when a force is applied to the fixing bracket via the support member or the first gear, the deformation of the fixing bracket can be prevented by utilizing the rigidity of the plate member, and the meshing between the first gear and the second gear can be further prevented from becoming shallow.
(3) The vehicle seat according to (2), in which
the one end of the restriction member is fastened to the plate member and the fixing bracket.

According to (3), when a force is applied to the fixing bracket via the support member or the first gear, the deformation of the fixing bracket can be prevented by utilizing the rigidity of the plate member, and the meshing between the first gear and the second gear can be further prevented from becoming shallow.
(4) The vehicle seat according to (2) or (3), in which
the fixing bracket includes:
   a first surface portion (first surface portion 641) fastened to the frame;
   a second surface portion (second surface portion 642) fastened to the frame;
   a third surface portion (third surface portion 643) fastened to the electric drive device; and
   a tubular portion (tubular portion 644) protruding from the third surface portion toward the frame,
the third surface portion is provided between the first surface portion and the second surface portion and is provided at a position farther from the frame than the first surface portion and the second surface portion, and
the plate member is fastened to the support member and the frame together with the fixing bracket between the first and second surface portions and the frame, and has a region (third region 653) disposed between the third surface portion and the frame.

According to (4), the fixing bracket can be firmly fixed to the support member and the frame by the plate member, and thus even when a force is applied to the support member or the first gear, the force transmitted to the fixing bracket can be dispersed, and the deformation of the fixing bracket can be prevented. By preventing the deformation of the fixing bracket, the displacement of the first gear can be prevented, and the meshing between the first gear and the second gear can be further prevented from becoming shallow.
(5) The vehicle seat according to (4), in which
the drive link member includes:
   a first region (first region 614) facing the frame with the second gear interposed therebetween;
   a second region (second region 615) located closer to the frame than the first region; and
   a third region (third region 616) connecting the first region and the second region,
the second gear is fastened to the first region, and
a shortest distance (distance L3) between a fastening point (fastening member V2) closest to the third region among fastening points of the first region with the second gear and a boundary (boundary BL) between the first region and the third region is 15 mm or more and 24 mm or less.

According to (5), the deformation of the drive link member can be prevented.

What is claimed is:

1. A vehicle seat comprising:
a seat cushion;
a height adjustment mechanism for the seat cushion;
a drive link member provided with a second gear meshing with a first gear supported by the seat cushion, and configured to be pivoted according to pivoting of the first gear;
a long hole provided in the drive link member and having a shape along an arc of a circle centered on a pivoting center of the drive link member;
a restriction member inserted into the long hole, supported at one end by the seat cushion, and configured to restrict a pivoting range of the drive link member; and
a support member configured to support an other end of the restriction member and support a shaft of the first gear, wherein
in a direction connecting the pivoting center of the drive link member and the restriction member, a first distance between an end edge of the long hole on a second gear side and the restriction member is smaller than a second distance between an end edge of the long hole on a side opposite to the second gear side and the restriction member.

2. The vehicle seat according to claim 1, further comprising:
an electric drive device provided on a side opposite to the support member across a frame of the seat cushion, and configured to drive the first gear;
a fixing bracket provided between the electric drive device and the frame, and configured to fix the electric drive device to the frame; and
a plate member provided between the fixing bracket and the frame.

3. The vehicle seat according to claim 2, wherein
the one end of the restriction member is fastened to the plate member and the fixing bracket.

4. The vehicle seat according to claim 2, wherein
the fixing bracket includes:
a first surface portion fastened to the frame;
a second surface portion fastened to the frame;
a third surface portion fastened to the electric drive device; and
a tubular portion protruding from the third surface portion toward the frame,
the third surface portion is provided between the first surface portion and the second surface portion, and is provided at a position farther from the frame than the first surface portion and the second surface portion, and
the plate member is fastened to the support member and the frame together with the fixing bracket between the first and second surface portions and the frame, and has a region disposed between the third surface portion and the frame.

5. The vehicle seat according to claim 4, wherein
the drive link member includes:
a first region facing the frame with the second gear interposed therebetween;
a second region located closer to the frame than the first region; and
a third region connecting the first region and the second region,
the second gear is fastened to the first region, and
a shortest distance between a fastening point closest to the third region among fastening points of the first region with the second gear and a boundary between the first region and the third region is 15 mm or more and 24 mm or less.
